(19) United States
(12) Patent Application Publication
(10) Pub. No.: US 2026/0147816 A1
(43) Pub. Date: May 28, 2026

(54) INFORMATION PROCESSING APPARATUS

(71) Applicant: TOYOTA JIDOSHA KABUSHIKI KAISHA, Toyota-shi (JP)

(72) Inventor: Gentaro KOGANO, Tokyo-to (JP)

(73) Assignee: TOYOTA JIDOSHA KABUSHIKI KAISHA, Toyota-shi (JP)

(21) Appl. No.: 19/345,566

(22) Filed: Sep. 30, 2025

(30) Foreign Application Priority Data
Nov. 28, 2024 (JP) 2024-207362

(51) Int. Cl. G06F 16/338; G06F 40/279; G06F 40/40; H04L 51/216

(52) U.S. Cl. CPC G06F 16/338; G06F 40/279; G06F 40/40; H04L 51/216

(57) ABSTRACT

An information processing apparatus includes: a storage unit that is configured to store chat data about a chat between a user and a large language model, in association with the user; a display unit that is configured to display history information about the chat; and a receiving unit that is configured to receive an input from the user. The history information includes a keyword extracted from the chat data. In a case where the receiving unit receives an input of the user selecting the keyword, the display unit displays an utterance related to the keyword, from among a plurality of utterances included in the chat data.

This application is based upon and claims the benefit of priority from Japanese Patent Application No. 2024-207362, filed on Nov. 28, 2024, the disclosure of which is incorporated herein in its entirety by reference.

### TECHNICAL FIELD

### Embodiments of the Present Disclosure Relate to Technical Fields of an Information

processing apparatus.

### BACKGROUND ART

As this type of apparatus, there is proposed an apparatus that generates query data based on documents in a language model and that utilizes a pair of the documents and the query data, for learning of a search model for conversational bots (see JP2023-076413A), for example.

As the conversational bots, there are proposed chatbots using large language models (LLMs). There are limitations on the length of a series of chats that are recordable by the chatbots. Consequently, in a case where the length of a series of chats reaches a predetermined length limit, a user needs to start a new chat. As a result, the user is likely to re-enter documents related to the same questions as those previously asked. Note that the large language models are language models constructed by using very large datasets and a deep learning technology.

### SUMMARY

In view of the above-described problems, it is an object of the present disclosure to provide an information processing apparatus that allows a user to relatively easily review his/her chat history.

An information processing apparatus according to an aspect of the present disclosure is an information processing apparatus including: a storage unit that is configured to store chat data about a chat between a user and a large language model, in association with the user; a display unit that is configured to display history information about the chat; and a receiving unit that is configured to receive an input from the user, wherein the history information includes a keyword extracted from the chat data, and in a case where the receiving unit receives an input of the user selecting the keyword, the display unit displays an utterance related to the keyword, from among a plurality of utterances included in the chat data.

### BRIEF DESCRIPTION OF THE DRAWINGS

FIG. 1 is a block diagram illustrating an example of a configuration of an information processing apparatus according to an embodiment;

FIG. 2 is a diagram illustrating an example of a display screen; and

FIG. 3 is a diagram illustrating another example of the display screen.

### EMBODIMENT

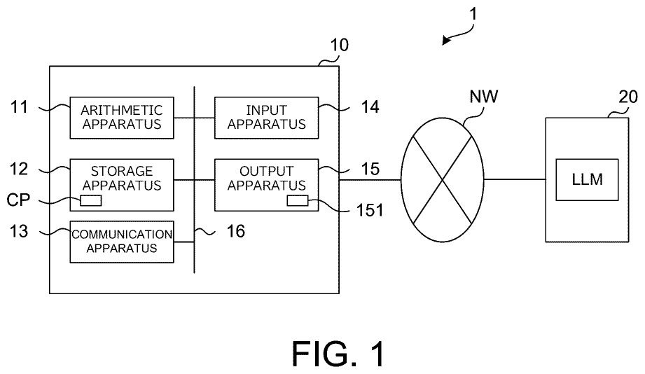

An information processing apparatus according to an embodiment will be described with reference to FIG. 1 to FIG. 3. In FIG. 1, an information processing apparatus 10 includes an arithmetic apparatus 11, a storage apparatus 12, a communication apparatus 13, an input apparatus 14, and an output apparatus 15. The arithmetic apparatus 11, the storage apparatus 12, the communication apparatus 13, the input apparatus 14, and the output apparatus 15 are connected via a data bus 16. The information processing apparatus 10 may be a personal computer, a tablet terminal, or a smartphone.

The arithmetic apparatus 11 may include a processor. The arithmetic apparatus 11 may include a single processor or a plurality of processors. That is, the arithmetic apparatus 11 may include one or more processors. The processor may be a multi-core processor. In a case where the arithmetic apparatus 11 includes a single processor that is a multi-core processor, it can be said that the arithmetic apparatus 11 logically includes a plurality of processors.

The processor may be, for example, at least one of a CPU (Central Processing Unit), a GPU (Graphics Processing Unit), a FPGA (Field Programmable Gate Array), and a TPU (Tensor Processing Unit).

The storage apparatus 12 may be, for example, at least one of a RAM (Random Access Memory), a ROM (Read Only Memory), a hard disk apparatus, a magneto-optical disk apparatus, an SSD (Solid State Drive), and an optical disk array. That is, the storage apparatus 12 may be realized by a single apparatus or by a plurality of apparatuses.

The communication apparatus 13 may be configured to communicate with an apparatus external to the information processing apparatus 10. The communication apparatus 13 may perform wired communication or wireless communication.

The input apparatus 14 is an apparatus that is configured to receive an input of information to the information processing apparatus 10 from an external source. The input apparatus 14 may include an operating apparatus (e.g., a keyboard, a mouse, a touch panel, etc.) that is operable by a user of the information processing apparatus 10. The input apparatus 14 may include a recording medium reading apparatus that is configured to read information recorded on a recording medium that is attachable to or detachable from the information processing apparatus 10, such as a USB (Universal Serial Bus) memory. In a case where information is inputted to the information processing apparatus 10 via the communication apparatus 13 (in other words, in a case where the information processing apparatus 10 acquires information via the communication apparatus 13), the communication apparatus 13 may function as an input apparatus.

The output apparatus 15 is an apparatus that is configured to output information to an outside of the information processing apparatus 10. The output apparatus 15 includes a display apparatus 151 that is configured to output visual information such as text/characters and images, as the aforementioned information. The output apparatus 15 may also include a speaker that is configured to output auditory information such as voice/sound, as the aforementioned information. The output apparatus 15 may also include a vibration motor that is configured to output tactile information such as vibrations, as the aforementioned information. The output apparatus 15 may include a printer. The output apparatus 15 may also be configured to output information to the recording medium that is attachable to or detachable from the information processing apparatus 10, such as a USB memory. In a case where the information processing apparatus 10 outputs information via the communication apparatus 13, the communication apparatus 13 may function as an output apparatus.

The storage apparatus 12 is configured to store desired data. The storage apparatus 12 may store therein a computer program CP to be executed by the arithmetic apparatus 11. The storage apparatus 12 may temporarily store data that are used by the arithmetic apparatus 11 when the arithmetic apparatus 11 is executing the computer program CP.

The computer program CP may be recorded on a computer-readable, non-transitory recording medium. In this case, the computer program CP may be stored in the storage apparatus 12 by reading the aforementioned recording medium with a not-illustrated recording medium reading apparatus provided in the information processing apparatus 10. The recording medium to be used may be at least one of an optical disk, a magnetic medium, a magneto-optical disk, a semiconductor memory, and any other medium that is configured to store a program. The computer program CP may also be acquired from a not-illustrated apparatus external to the information processing apparatus 10 via the communication apparatus 13. In other words, the computer program CP may be downloaded from an external apparatus to the storage apparatus 12 of the information processing apparatus 10.

The arithmetic apparatus 11 (e.g., a processor) may perform processing to be performed by the information processing apparatus 10 together with the storage apparatus 12 in which the computer program CP is stored (in other words, together with the storage apparatus 12 and the computer program CP stored therein). For example, by the arithmetic apparatus 11 executing the computer program CP, a logical function block for performing the processing to be performed the information processing apparatus 10, may be realized in the arithmetic apparatus 11 (e.g., in the processor).

The information processing apparatus 10 is accessible to a server 20 that provides a chat service (e.g., a chatbot) using a large language model (LLM) via a network NW. That is, the information processing apparatus 10 and the server 20 are configured to communicate via the network NW. The server 20 may be a cloud server. The network NW may be a wide area network such as the Internet, or a narrow area network such as a local area network (LAN). The information processing apparatus 10 and the server 20 may constitute an information processing system 1.

Let us assume that the computer program CP stored in the storage apparatus 12 includes a computer program related to an application for using the aforementioned chat service (hereinafter referred to as a “chat application” as appropriate). By the user of the information processing apparatus 10 starting the chat application via the input apparatus 14, the user can use the aforementioned chat service.

For example, the user may input a document (e.g., a question or a request) in an input field of the chat application via the input apparatus 14. The user may perform not only text input, but also voice input. The arithmetic apparatus 11 may transmit first information indicating the document, to the server 20 via the communication apparatus 13. Upon receiving the first information, the server 20 may input the document indicated by the first information (in other words, a prompt) into the large language model. The server 20 may acquire a response to the document outputted from the large language model. The server 20 may transmit second information indicating the response, to information processing apparatus 10. Upon receiving the second information, the arithmetic apparatus 11 of the information processing apparatus 10 may control the display apparatus 151 such that the response indicated by the second information is displayed on a screen related to the chat application.

The aforementioned chat service may be a chat service utilizing a mechanism (Retrieval-Augmented Generation: RAG) in which the large language model is combined with retrieval from a specific information source (a so-called knowledge base), thereby providing the large language model with a unique information source.

For example, the user may input a document (e.g., a question or a request) in an input field of the chat application via the input apparatus 14. The arithmetic apparatus 11 may search the knowledge base, based on the inputted document. The arithmetic apparatus 11 may transmit third information indicating the inputted document and a search result, to the server 20 via the communication apparatus 13. Upon receiving the third information, the server 20 may input the document and the search result indicated by the third information (in other words, a prompt) into the large language model. The server 20 may acquire a response to the document outputted from the large language model. The server 20 may transmit fourth information indicating the response, to the information processing apparatus 10. Upon receiving the fourth information, the arithmetic apparatus 11 of the information processing apparatus 10 may control the display apparatus 151 such that the response indicated by the fourth information is displayed on a screen related to the chat application.

The chat application has, as a part of its functionality, a function of storing chat data about a chat between the user and the large language model (in other words, chat history) in the chat service. In a case where the chat data are stored, for example, the arithmetic apparatus 11 stores the chat data in the storage apparatus 12 in association with the user. By the way, there are limitations on the length of a series of chats that are recordable in the chat service. Therefore, in a case where the length of a series of chats reaches a predetermined length limit, the user needs to start a new chat. In this case, the arithmetic apparatus 11 treats chat data about a current chat and chat data about the new chat, as different pieces of data.

The chat data (in other words, chat history) stored in the storage apparatus 12 may be displayed on a screen related to the chat application. At this time, even if, for example, a saving date and time of the chat data, or an initial part of a plurality of utterances included in the chat data, is displayed on the screen, it is difficult for the user to grasp the content of chats in the past from the display on the screen. As a result, the user is likely to re-enter documents related to the same questions as those previously asked.

The arithmetic apparatus 11 of the information processing apparatus 10 according to the present embodiment extracts one or more keywords from one or more pieces of chat data stored in the storage apparatus 12. Note that various existing aspects are applicable to a method of extracting the keywords from the chat data (i.e., text data). Therefore, a detailed description of the method of extracting the keywords is omitted. The arithmetic apparatus 11 may assign/add metadata about the keywords to utterances related to the extracted keywords (e.g., utterances including the keywords) from among a plurality of utterances included in the one or more pieces of chat data. The arithmetic apparatus 11, however, may not assign/add metadata about the keywords to the utterances.

The arithmetic apparatus 11 controls the display apparatus 151 such that the extracted one or more keywords are displayed on a screen related to the chat application, as history information on chats related to the user. In a case where there are a relatively large number of extracted keywords, the arithmetic apparatus 11 may rank each keyword, based on a frequency of appearance of the keyword. The arithmetic apparatus 11 may then control the display apparatus 151 such that only a predetermined number of keywords with relatively high ranks are displayed on the screen related to the chat application.

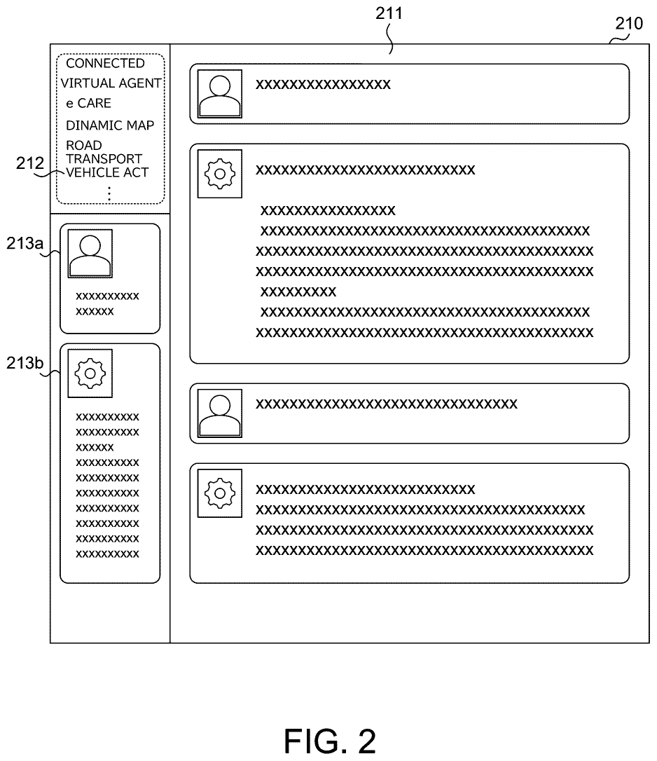

For example, the display apparatus 151 may display a screen 210 illustrated in FIG. 2. On the screen 210, the content of an ongoing chat may be displayed in an area 211. One or more keywords serving as the history information may be displayed in the area 212.

In a case where the user selects a single keyword displayed in the area 212 via the input apparatus 14, the arithmetic apparatus 11 controls the display apparatus 151 such that utterances related to the selected single keyword (here, utterances 213a and 213b) are displayed on a screen related to the chat application (e.g., the screen 210). That is, in a case where the input apparatus 14 receives an input of the user selecting a single keyword, the display apparatus 151 displays the utterances related to the selected single keyword from among a plurality of utterances included in the chat data.

For example, the arithmetic apparatus 11 may extract, from the plurality of utterances included in the chat data, utterances to which metadata about a single keyword are assigned/added, thereby extracting the utterances related to the single keyword. For example, the arithmetic apparatus 11 may extract the utterances related to the single keyword from the plurality of utterances included in the chat data, based on the single keyword.

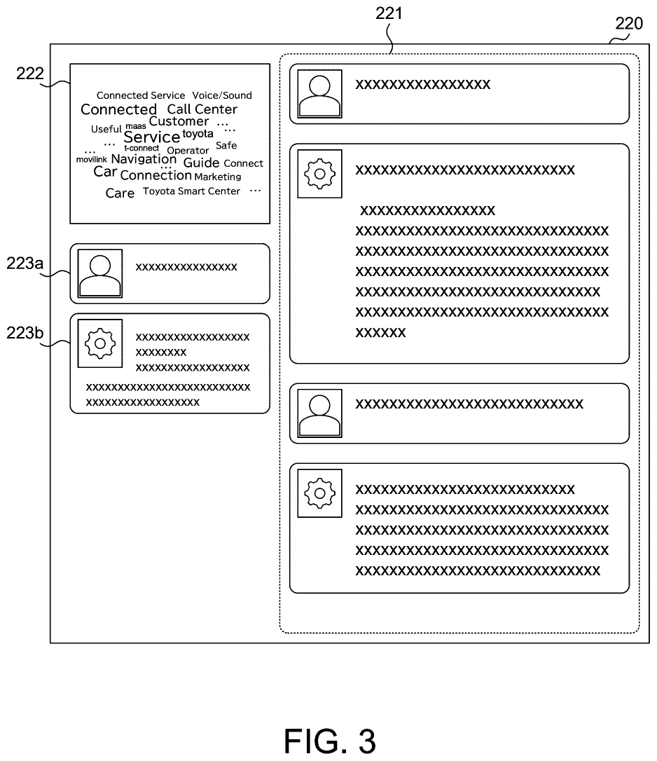

For example, the display apparatus 151 may display a screen 220 illustrated in FIG. 3. On the screen 220, the content of an ongoing chat may be displayed in an area 222. In the area 222, a plurality of keywords serving as the history information may be displayed as a word cloud. Note that various existing aspects are applicable to a method of generating the word cloud. Therefore, a detailed description of the method of generating the word cloud is omitted.

In a case where the user selects a single keyword displayed in the area 222 via the input apparatus 14, the arithmetic apparatus 11 controls the display apparatus 151 such that utterances related to the selected single keyword (here, utterances 223a and 223b) are displayed on a screen related to the chat application (e.g., the screen 220).

The user of the information processing apparatus 10 may set or change a period of the chat data (in other words, chat history) from which keywords are extracted via the input apparatus 14. In this case, the arithmetic apparatus 11 may extract one or more keywords from the chat data in the period that is set or changed by the user. The arithmetic apparatus 11 may control the display apparatus 151 such that the extracted one or more keywords are displayed as the history information on a screen related to the chat application (e.g., the screens 210 and 220). The screens 210 and 220 are examples, and a screen configuration is not limited to these examples. Furthermore, the keywords described in FIG. 2 and FIG. 3 are also examples.

### Technical Effect

In the information processing apparatus 10, the keywords extracted from the chat data about a chat between the user and the large language model are displayed as the history information about the chat. In a case where the user selects the displayed keywords via the input apparatus 14, utterances related to the selected keywords are displayed. Thus, using the keywords in which the user is interested, the user can confirm the utterances related to the keywords. Therefore, according to the information processing apparatus 10, the user can confirm the chat history, relatively easily. Consequently, it is possible to prevent the user from re-entering documents related to the same questions as those previously asked.

An aspect of the present disclosure derived from the embodiment described above will be explained below.

An information processing apparatus according to an aspect of the present disclosure is an information processing apparatus including: a storage unit that is configured to store chat data about a chat between a user and a large language model, in association with the user; a display unit that is configured to display history information about the chat; and a receiving unit that is configured to receive an input from the user, wherein the history information includes a keyword extracted from the chat data, and in a case where the receiving unit receives an input of the user selecting the keyword, the display unit displays an utterance related to the keyword, from among a plurality of utterances included in the chat data. In the aforementioned embodiment, the “storage apparatus 12” corresponds to an example of the “storage unit,” the “display apparatus 151” corresponds to an example of the “display unit,” and the “input apparatus 14” corresponds to an example of the “receiving unit.”

In an example of the information processing apparatus, the history information may include a plurality of keywords extracted from the chat data, and the display unit may display a word cloud including the plurality of keywords, as the history information.

The present disclosure is not limited to the above-described examples and is allowed to be changed, if desired, without departing from the essence or spirit of the invention which can be read from the claims and the entire specification. An information processing apparatus with such changes is also included in the technical concepts of the present disclosure.

### DESCRIPTION OF REFERENCE NUMERALS

10 . . . Information processing apparatus, 11 . . . arithmetic apparatus, 12 . . . storage apparatus, 13 . . . communication apparatus, 14 . . .input apparatus, 15 . . .output apparatus, 151 . . . Display unit

What is claimed is:

1. An information processing apparatus comprising:
a storage unit that is configured to store chat data about a chat between a user and a large language model, in association with the user;
a display unit that is configured to display history information about the chat; and
a receiving unit that is configured to receive an input from the user, wherein
the history information includes a keyword extracted from the chat data, and
in a case where the receiving unit receives an input of the user selecting the keyword, the display unit displays an utterance related to the keyword, from among a plurality of utterances included in the chat data.

2. The information processing apparatus according to claim 1, wherein
the history information includes a plurality of keywords extracted from the chat data, and
the display unit displays, as the history information, a word cloud including the plurality of keywords.
